(19) United States
(12) Patent Application Publication
(10) Pub. No.: US 2003/0167337 A1
(43) Pub. Date: Sep. 4, 2003

(54) Multimedia virtual streaming for narrowband broadband IP-access network

(76) Inventors: William Jia Liew, Montville, NJ (US); Chunyan Liu, Montville, NJ (US)

Correspondence Address: Chunyan Tricia Liu OR William Liew, 12 Mountain Ave, Montville, NJ, 07045, US

(21) Appl. No.: 09/871,425

(22) Filed: May 31, 2001

(51) Int. Cl. G06F 15/16

(52) U.S. Cl. 709/231; 709/230

(57) ABSTRACT

A multimedia Internet-protocol (IP) data delivery system using a virtual streaming method. The invented system comprises a plurality of clients, each of which comprising a downloading unit, a media data cache and a playing unit, a plurality of IP ports connecting the clients to the Internet, an IP port controlling means controlling the connection between the client and the IP-port and a scheduling means scheduling the downloading tasks of the downloading unit and the playing tasks of the playing unit independently. In the cases of many of broadband access networks using the virtual streaming method in this invention, downloading a media file takes less time to complete than playing the media file does, and the IP ports can be released after the downloading is completed and before the playing is completed. As a result, in comparison with conventional streaming methods, a number of IP ports can accommodate more number of subscribers, or the effective throughput can be higher because of less packet collision occurs. In the cases of most of narrowband networks, the virtual streaming method in this invention makes it possible to delivery high-quality IP data into the media cache and, independently from the downloading activity, play the media file with VHS quality when the media file data in the media data cache is available.

### BACKGROUND OF THE INVENTION

This invention relates to a multimedia Internet-protocol (IP) data delivery and management system, and accordingly to the means and steps of achieving high efficiency of utilizing IP circuit-ports and bandwidth for the multimedia IP-data delivery over IP-access infrastructures.

More and more Multimedia data, such as movies, TV programs and TV-quality advertisements, are delivered over IP-access networks. The IP-access networks can be classified into narrowband IP-access networks and broadband IP-access networks. A narrowband IP-access network has an IP-access channel with a bandwidth less than 120 kilobits per second (kbps), such as an analog-phone MODEM channel or an ISDN line. A broadband IP-access network, such as DDN, DSL, Ethernet LAN and cable networks, has an IP-access channel with a bandwidth greater than 120 kilobits per second and can provide higher speed IP-access than an analog telephone line.

Any multimedia file needs to be played at a certain data rate in order to maintain its quality of service (QOS). However, different IP-access networks have different data rates. For example, the maximum modem data rate is 56 kbps, an ISDN line has a data rate of 64 kbps or 128 kbps, a DDN line has a multiple of 64 kbps, and a DSL modem provides 1 Mbps to 8 Mbps.

In a narrow-band network, the speed of downloading an IP multimedia file is less than the speed needed by playing the media file, the quality of playing the media file becomes very poor if a conventional real-time streaming method is used. For example, the speed of an analog modem is less than 56 kbps, and the typical data rate of a MPEG4 file is greater than 200 kbps, then the conventional streaming of the MPEG4 file over the analog modem network results in very poor quality.

On the other hand, if the available bandwidth is greater than the speed needed by playing the media file, the quality of playing the media file is guaranteed. However, expensive IP-access network resources, such as ISP circuit ports and/or bandwidth, could be wasted if efficient downloading/port management is not implemented, as is the case for a conventional streaming method where the media playing speed is equal to the downloading speed. In the conventional streaming method, the downloading speed is less than the available bandwidth. Therefore an IP circuit port is occupied for a much longer time by using the conventional streaming method than a method utilizing fully the available bandwidth. In an Ethernet LAN, the conventional streaming method uses a slower downloading speed and results in a longer downloading time and more packet collision and significantly lower throughput than a method fully utilizing the available bandwidth.

In U.S. Pat. No. 6,085,252, it is pointed out that the Real-time Protocol (RTP) is a current de facto standard for delivering real-time contents over the Internet (or other networks based on an IP protocol). The Real-time Protocol replaces the conventional transmission control protocol (TCP) with a framework that real-time applications can use directly for data transport. Currently, the RTP standard supports a first type of message, namely one for carrying the media content data or streaming data. Typically, a separate protocol the Real-Time Control Protocol (RTCP) is used with RTP to pass control messages for session management, rate adaptation and the like. While the Real-time Protocol can be used to deliver multimedia streaming data over computer networks, the existing architecture, such as TCP/IP, has not proven robust enough to provide high quality presentation using best effort network services such as those provided by the Internet. For the narrow band IP-access network, the RTP does not provide any quality-of-service (QOS). For the broadband IP-access network, the RTP always occupies a high-data-rate circuit port even though it requires only 150 kbps to play a typical MPEG4 movie file, which is far less than the data rate that a typical DSL or broadband wireless circuit port can support.

An invention (U.S. Pat. No. 6,085,252) provides a device, system and method for real-time streaming of a multimedia file stored in a remote server over a packet network to a multimedia client connected to the same network via a low-speed access link such as an analog telephone line. It designed a packet retransmission strategy to provide improved QoS with respect to both quality and delay. However, it still does not solve the problems of inadequate QoS of narrowband IP-access networks and wasting circuit ports/throughput of broadband IP-access networks.

Existing systems try to improve QoS of narrow-band IP-access networks, but their QoS is still poor when a multimedia file needs a higher playing speed than the available bandwidth. For broadband IP-access networks, expensive circuit ports or bandwidth are wasted when using existing media streaming methods.

An object of this invention is to design a multimedia IP data delivery and management system which achieves maximum efficiency of both narrow-band bandwidth and broadband circuit-ports/throughput by using a method different than the conventional streaming approach.

Another object of this invention is to design a multimedia IP data delivery and management system which downloads multimedia IP data at a speed different than the media file playing speed, and manages intelligently the connections between clients and IP ports of the IP access system to achieve the maximum efficiency of both narrow-band bandwidth and broadband circuit-ports/throughput.

### SUMMARY OF THE INVENTION

The goal of this invention is to design a method and system of Multimedia Virtual Streaming for IP access networks, that is, an efficient method and system which transparently and seamlessly manages downloading/playing of multimedia IP files and IP-port-client connections with the most efficient use of any narrowband or broadband IP-access networks. The invention can both maintain a good QoS and save IP-access circuit ports and/or increase the throughput.

The Multimedia Virtual Streaming system for narrowband and broadband IP-access networks in this invention comprises IP ports (ADSL/modem circuit ports or Ethernet/cable ports or other IP ports), IP-port controller, Media File Servers and Clients. Each Client comprises a Downloading Unit, a Media data cache, a Playing Unit and an IP-port connection control unit.

The IP ports are ADSL/modem circuit ports, or Ethernet/cable ports, or any other IP ports. The clients are physically connected to the IP ports during the multimedia data transfer between the clients and the media file servers.

The IP-port controller implements intelligent management of IP-port connections between the IP ports and the clients to achieve the maximum efficiency of utilizing the IP ports and bandwidth.

The Media File Servers can be Web servers, FTP servers or hardware data centers (e.g. those made by CacheFlow Inc.). They store a large quantity of multimedia data and distribute media data through their connections to the IP ports and clients. The file servers may be physically connected to the IP ports, or may be connected to the Internet without directly being connected to the IP ports.

A physical connection is established between the client and an IP port, and a logical IP connection is established between the client and a file server. The logical IP connections can be running concurrently without interfering each other. ‘Connection(s)’ referred thereafter in this text denote to ‘logical IP connection(s).’

The Playing unit of the client plays the media files using the data stored in the cache. The Playing unit does not use the data from the downloading unit directly, but uses the data from the cache. The playing is scheduled by the scheduling unit which checks the availability of the media file in the cache and a given time schedule to determine if the media file should be played.

The IP-port connection control unit detects the status of downloading the media files and manages the IP-port connection to achieve maximum efficiency of utilizing the IP ports and bandwidth.

If the available bandwidth is greater than the speed of playing, the full bandwidth is utilized to download the multimedia IP data at the maximum speed which is greater than the playing speed. The multimedia file could be played while the multimedia data is being downloaded, or the file could played after the downloading, depending on different schedules. In the broadband case, the downloading takes less time to complete than playing. Therefore the IP ports can be released by either the IP-port controller or the IP-port connection control unit after the downloading is completed and before the playing is completed. In this manner, a number of IP ports can accommodate more number of subscribers, or the effective throughput can be higher because of less packet collision than the conventional streaming.

In the case of narrow-band, the available bandwidth is less than the playing speed, then the multimedia files need to be downloaded and cached before they are available for playing. This method results in a high QOS for delivering and playing multimedia IP files over narrow-band IP-access networks.

The method of downloading multimedia IP-data at a different speed than playing the multimedia IP-data and efficiently managing the IP-port-client connection is referred to as virtual streaming. The virtual streaming method is different than the conventional streaming approach where the downloading speed is always equal to the playing speed.

The virtual streaming method achieves several advantages over the conventional streaming approach.

First, for narrow-band networks, the virtual streaming makes it possible to play a high quality large media file, while the conventional streaming cannot achieve this high-quality playing and has to reduce the media file data rate and its quality to accommodate the slower IP network.

Second, for broad-band networks, the virtual streaming saves IP circuit ports by downloading the media file at the maximum available speed and releasing the IP circuit ports when the downloading is completed and before the playing is completed, while the conventional streaming downloads the media file at the same speed as the playing speed and occupies the IP circuit port much longer than the virtual streaming. For Ethernet or cable IP ports, the virtual streaming occupies the Ethernet line for much less time than the conventional streaming and therefore results in much less collision and much higher throughput than the conventional streaming.

### BRIEF DESCRIPTION OF THE DRAWINGS

FIG. 1 is a schematic diagram illustrating one embodiment of the Multimedia Virtual Streaming for Narrowband and Broadband Access Network.

FIG. 2 illustrates a logic flow chart of the software program in the IP-port connection control unit and/or the IP-port controller.

### DETAILED DESCRIPTION

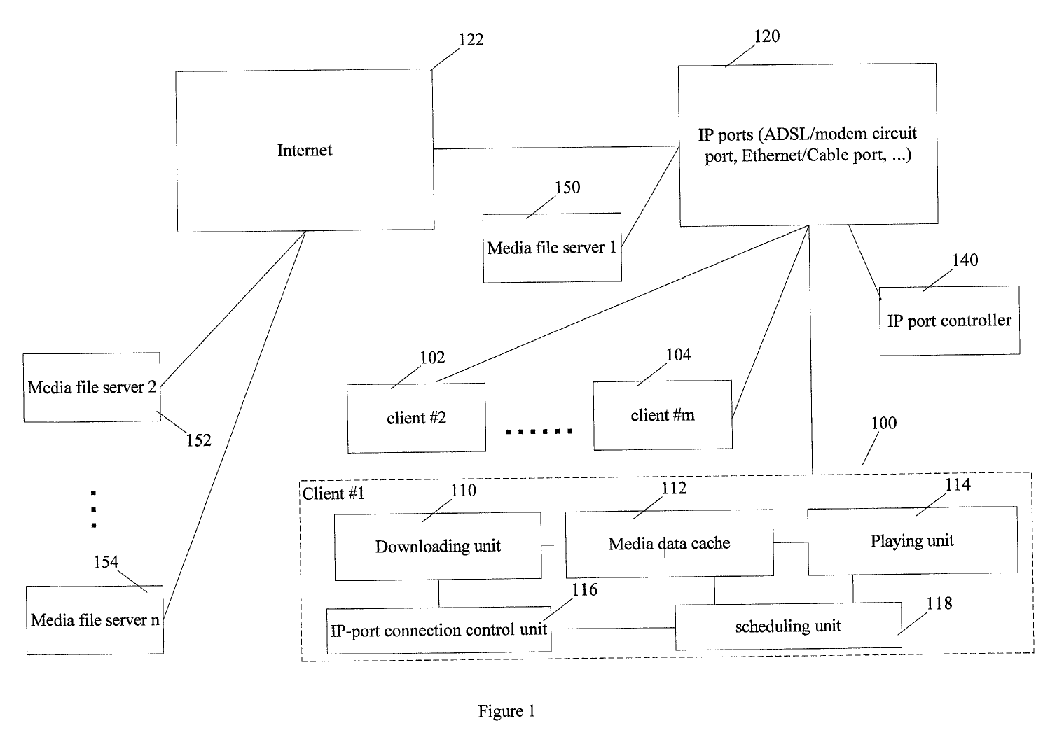

Referring to FIG. 1, the IP data delivery and management system using the virtual streaming comprises a plurality of clients 100, 102, 104, a plurality of media file servers 150, 152, 154, IP ports 120 and a IP-port controller 140. All the IP ports, clients, IP-port controller and media file servers are connected to the Internet 122.

The IP ports 120 are ADSL/modem circuit ports, Ethernet/cable ports, and any other IP ports.

In one embodiment, the ADSL/modem circuit ports 120 are dedicated ports always occupied by one user as long as the user is on-line. Only after the circuit port is released, another user can use the same circuit port. Therefore the length of time for which a circuit port is occupied by a user is directly related to the number of users the IP ports are able to support. For example, if an average user occupies one circuit port for 5 minutes per hour, then each circuit port can support around 10 users in an average hour if the users are evenly distributed during the hour. If a user stays on line all the time during the hour, then the circuit port can support only one user. The difference between the two cases is 10 times.

In another embodiment, the Ethernet/cable ports 120 are connected to clients through Ethernet hubs. All users are sharing the same bandwidth if they are downloading media files simultaneously through the Ethernet ports. In an Ethernet, the effective throughput drops exponentially as the number of users increases who are sharing the same bandwidth This dramatic performance drop is caused by packet collision when packets from all users are sharing the same bandwidth. For example, if only one user is using a 100 mega bits per second (mbps) Ethernet during a 5-minute period, then the user can download a file at the speed close to 100 mbps. If 10 users use the Ethernet during different 5-minute period in a given hour, then every user can achieve 100 mbps throughput. On the other hand, if the 10 users use the Ethernet simultaneously during the hour, then every user can get less than 1 mbps throughput. The throughput difference between the two cases is 100 times.

The IP-port controller 140 is a software program running in an ISP server or an independent server. The IP-port controller 140 manages the connection between the clients and the IP ports.

The client 100 comprises a downloading unit 110, a media data cache 112, a playing unit 114, an IP-port connection control unit 116 and a scheduling unit 118.

The media file servers 150, 152, 154 can be WWW servers, HTTP servers, FTP servers or other servers.

If the connection between the IP ports 120 and the client 100 is a narrow-band connection, that is, the media file playing speed is greater than the available bandwidth, then the downloading unit 110 downloads at the available full speed the media file data from one of the media file servers through the IP ports 120. The downloaded media data are stored in the cache 112. The scheduling unit 118 checks if the media file has been completely downloaded and schedules the media file playing after the downloading is completed. For example, an MPEG4 file requires a data rate of more 160 kbps. If the IP port is a 56 kbps modem port, the file will be first downloaded from one the media file servers and stored in the cache 112. The file cannot be played during the downloading since the playing speed is greater than the downloading speed. After the file has been completely downloaded and cached in the cache 112, the scheduling unit 118 decides that the file is available for playing and schedules a play for the file. While it is feasible to play a high quality MPEG4 file through a narrow-band connection by using the virtual streaming method, it is impossible to play the same MPEG4 file through the narrow-band connection by using a conventional streaming method.

If the connection between the IP ports 120 and the client 100 is a broadband connection, that is, the available bandwidth is greater than the media file playing speed, the downloading unit 110 downloads the media file at the available full speed and the playing unit can play the file simultaneously if the playing is scheduled. Since the downloading speed is greater than the playing speed, the file is also cached in the cache 112 while being played. The downloading of the file is completed earlier than the playing of the file. After the downloading is completed and before the playing is completed, the IP-port connection control unit 116 and/or the IP-port controller 140 terminates the connection between the IP ports 120 and the client 100 to release the IP circuit port for other users or to reduce the packet collision and increase the effective throughput within the Ethernet.

For example, if the IP port 120 is a broad-band ADSL port with a data rate of around 1 mbps, the MPEG4 file playing speed is around 300 kbps and a one-hour movie has 1.08 giga bits, the virtual streaming method completes the downloading within 18 minutes and the IP-connection-control-unit/IP-port-controller releases the circuit port for other users for the rest of 42 minutes. Using the conventional streaming method, the same user occupies the circuit port for one hour. In this case, the efficiency of the virtual streaming in this invention is 3.3 times more efficient than the conventional streaming.

In another example, if the IP port 120 is an Ethernet port with a bandwidth of 100 mbps, the MPEG4 file playing speed is around 300 kbps and a one-hour movie has 1.08 giga bits, the virtual streaming method completes the downloading within 11 seconds if the client is the only one user using the Ethernet within the 11 seconds. During the one hour period, assuming 100 clients are watching the movie by using the virtual streaming method and their starting time is evenly distributed, then the 100 users can be easily supported. By using the conventional streaming method, if the same 100 clients are watching the movie and their starting time is evenly distributed during the one hour period, in more than 30-minute period more than 50 users are downloading through the Ethernet hub sharing the same 100-mega-bit bandwidth. Since the performance drops exponentially with the number of simultaneous users in an Ethernet because of the severe packet collision, the effective throughput of each client is less than 40 kbps during the 30-minute period. The 40 kbps throughput is much less than the 300 kbps playing speed. It is seen that the virtual streaming method in this invention can easily support the service of 100 clients watching the MPEG4 movie, while the conventional streaming method fails to support the same service.

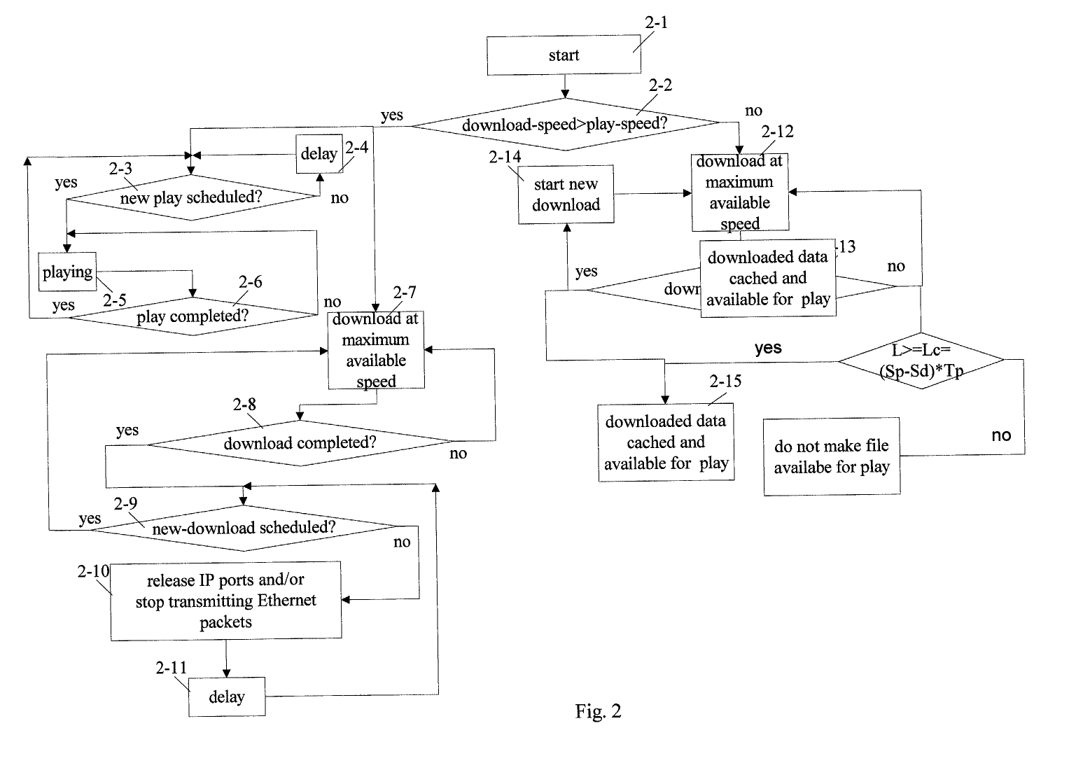

FIG. 2 illustrates a logic flow chart of the software program residing inside the IP-port connection control unit 116 and/or the IP-port controller 140, providing intelligent management of connections between the IP ports 120 and clients 100, 102, 104. At the initial step 2-1 the software program starts and then proceeds to step 2-2. Then at step 2-2 the downloading speed at the downloading unit 110 is compared to the playing speed at the playing unit 114. If the downloading speed is greater than the playing speed, i.e., the IP access is broadband, the software program proceeds to step 2-3. At step 2-3 it is checked whether a new play has been scheduled. If a new play has been scheduled, then at step 2-5 the scheduled play is played. If no new play is scheduled, then at step 24 it is delayed by a few seconds or minutes and the software program goes back to step 2-3 to check the new-play schedule again. At step 2-6, the software program checks if the play is completed. If the play is completed, the software program goes back to step 2-3 to check for the new play schedule, otherwise it goes back to continue playing. Parallel to step 2-3, the software program also goes to step 2-7 to download media files at maximum available speed. Then the software program checks if the download has been completed at step 28. If the download is completed, the software program goes to step 2-9 to check if a new download is scheduled. If the new download is scheduled, the software program goes back to step 2-7 for a new download. If a new download is not scheduled, the software program proceeds to step 2-10 to release IP ports 120 and/or stop transmitting Ethernet packets, and then proceeds to step 2-11 to delay for a few seconds or minutes and goes back to step 2-9 to check a new download schedule. If the download at step 2-7 is not completed, the download continues at the maximum available speed.

Also in FIG. 2, going back to step 2-2 again, the software program checks if the downloading speed is greater than the playing speed. If the downloading speed is not greater than the playing speed, i.e., the IP access is narrowband, the software program proceeds to step 2-12 to download at the maximum available speed. If the download is completed, then a new download is started at step 2-14, and the downloaded file is cached and available for play. If the download at step 2-12 is not completed, the download continues.

Still in FIG. 2 for the narrowband case, before the downloading of a media file is completed but when there is enough data stored in the Media Data Cache 112 such that the playing of the media file can also be started and there will be always enough data to supply to the Playing Unit 114 during the whole course of playing the media file. Assuming the data capacity stored in the Media Data Cache 112 in order to achieve this purpose is Lc mega-bit, the average downloading speed for one particular downloading task is Sd mega-bit/sec, the media file playing data rate at the playing unit is Sp mega-bit/sec. The total length of time needed to play the whole media file is Tp. Then, Lc is defined as (Sp−Sc)·Tp. That is, the data storage L in the Media Data Cache 112 needs to be larger than or equal to Lc.

Therefore paralleled with the route going back to 2-12 to continue to download, it is checked at step 2-16 if L>=Lc is satisfied. If yes, the media file can be made available for the playing unit 114 to play. If not, the media file will not be made available for the playing unit 114 to play.

The steps 2-2 and 2-8 in FIG. 2 implement the maximum-available-speed downloading in a broadband IP access network, i.e., the downloading speed greater than the playing speed, and the step 2-10 is the key to implement the maximum circuit-port and/or bandwidth efficiency.

The steps 2-2, 2-12 and 2-15 implement the multimedia downloading and playing in a narrowband IP access network, and make it possible to provide broadband video/audio services over a narrowband network.

While considerable emphasis has been herein on the preferred embodiment illustrated and described hereinabove, it will be appreciated that other embodiments of the invention can be made and that changes can be made in the preferred embodiment without departing from the principals of the present invention. Accordingly, it is to be distinctly understood that the foregoing descriptive matter is to be interpreted merely as illustrative of the invention and not as a limitation.

What is claimed is:

1. A multimedia IP-data delivery system comprising:
a plurality of IP ports connecting to the Internet;
at least one media file server containing a plurality of media files;
a plurality of clients connecting to said IP ports with each of said clients comprising:
a downloading unit,
a media data cache,
a playing unit,
wherein,
said downloading unit downloads said media files from said media file server at a downloading speed and stores said media files in said media data cache;
said playing unit draws data of said media file from said media data cache and plays said media file at a playing speed;
said downloading unit and said playing unit are operated independently and said downloading speed can be different than said playing speed.

2. The multimedia IP-data delivery system as defined in claim 1 wherein:
said downloading speed is greater than said playing speed;
said multimedia IP-data delivery system has an IP-port controlling means which disconnects said downloading unit from said IP ports once said downloading unit completes downloading all of said media files requested by said client either when said playing unit is playing or not playing one of said media files stored in said media data cache.

3. The multimedia IP-data delivery system as defined in claim 2 wherein:
said IP-port controlling means is an IP-port connection control unit connected to said client.

4. The multimedia IP-data delivery system as defined in claim 2 wherein:
said IP-port controlling means is an IP-port controller connected to said IP ports.

5. The multimedia IP-data delivery system as defined in claim 1 wherein:
said multimedia IP-data delivery system has a scheduling means scheduling playing and downloading each of said media files independently.

6. The multimedia IP-data delivery system as defined in claim 1 wherein:
said downloading speed is less than said playing speed;
said multimedia IP-data delivery system has a scheduling means which delays playing said media files until said media files are completely downloaded and stored in said media data cache.

7. The multimedia IP-data delivery system as defined in claim 1 wherein:
said downloading speed is less than said playing speed;
said multimedia IP-data delivery system has a scheduling means which delays playing said media files until the amount of data of said media file in said media data cache is determined to be sufficient enough so that the difference between said playing speed of said media file and said downloading speed does not cause drain of the data of said media file in said media data cache during the whole course of playing said media file.

8. The multimedia IP-data delivery system as defined in claim 1 wherein:
each of said clients comprises a software program implementing a process comprising the steps of:
(8-1) starting said software program and then proceeding to step 8-2,
(8-2) comparing said downloading speed to said playing speed, and proceeding to step 8-3 and step 8-7 if said downloading speed is greater than said playing speed, and proceeding to step 8-12 if said downloading speed is less than said playing speed,
(8-3) checking whether a new play has been scheduled, and proceeding to step 8-5 if a new play has been scheduled, or proceeding to step 8-4 if no new play is scheduled,
(8-4) going back to step 8-3 after a delay of a predetermined number of seconds,
(8-5) starting play of one of said media files scheduled by said scheduling unit, and proceeding to step 8-6,
(8-6) checking if said play is completed, and continuing said play if said play is not completed, and going back to step 8-3 if said play is completed,
(8-7) starting download of said media files at a maximum available speed, and proceeding to step 8-8,
(8-8) checking if said download has been completed, and proceeding to step 8-9 if said download is completed, and continuing said download if said download is not completed,
(8-9) checking if a new-download is scheduled, and going back to step 8-7 if said new-download is scheduled, and proceeding to step 8-10 if said new-download is not scheduled,
(8-10) releasing connection between said client and said IP ports, and proceeding to step 8-11,
(8-11) delaying for a predetermined number of seconds and going back to step 8-9 to check a new download schedule,
(8-12) starting narrowband download of said media files at a maximum available speed, and proceeding to step 8-13,
(8-13) proceeding to step 8-14 and step 8-15 if said narrowband download is completed, or continuing downloading if said narrowband download is not completed,
(8-14) starting a new download and proceeding to step 2-12,
(8-15) caching and making downloaded one of said media files available for playing.
